(19) United States
(12) Patent Application Publication
(10) Pub. No.: US 2022/0374675 A1
(43) Pub. Date: Nov. 24, 2022

(54) THREE-DIMENSIONAL TRACK PLANNING METHOD BASED ON IMPROVED PARTICLE SWARM OPTIMIZATION ALGORITHM

(71) Applicant: HARBIN INSTITUTE OF TECHNOLOGY, Harbin (CN)

(72) Inventors: Yuliang BAI, Harbin (CN); Ningyu WANG, Harbin (CN); Yongzhi SHAN, Harbin (CN); Long ZHANG, Harbin (CN); Liangchen XU, Harbin (CN); Xiaoguang WANG, Harbin (CN); Xiaodong MA, Harbin (CN)

(73) Assignee: HARBIN INSTITUTE OF TECHNOLOGY, Harbin (CN)

(21) Appl. No.: 17/867,685

(22) Filed: Jul. 19, 2022

(30) Foreign Application Priority Data
Jan. 18, 2022 (CN) 202210055769.8

(51) Int. Cl. G06N 3/00; G06F 17/10

(52) U.S. Cl. CPC G06N 3/006; G06F 17/10

(57) ABSTRACT

A three-dimensional track planning method based on improved particle swarm optimization algorithm is disclosed. During the process of searching an optimal three-dimensional track in a track space, Different inertia weights are set in different particle swarm iterative evolution stages. A maximum inertia weight is used to make global convergence in a set early stage of evolution, and a minimum inertia weight is used to make local convergence in a set late stage of evolution. Disturbance mutation operation in a motion process of particles is added based on swarm diversity. Infeasible particles are selected based on constraints. Constraint violation functions of infeasible particles are compared, and infeasible particles with small constraint violation functions are kept. The disclosure makes full use of all particles, so that the infeasible solutions can also provide help for the overall optimization of the swarm, and ensures the reliability and efficiency of track planning

### CROSS REFERENCE TO RELATED APPLICATION

This patent application claims the benefit and priority of Chinese Patent Application No. 202210055769.8 filed on Jan. 18, 2022, the disclosure of which is incorporated by reference herein in its entirety as part of the present application.

### TECHNICAL FIELD

The present disclosure relates to the technical field of unmanned aerial vehicle track planning, and more specifically, to a three-dimensional track planning method based on improved particle swarm optimization algorithm.

### BACKGROUND ART

Since the birth of unmanned aerial vehicle (UAV), it has been mainly used in military operations and reconnaissance. As a kind of high-tech weapon of intelligence and information, UAVs show excellent performance in reconnaissance, surveillance, communication and long-range strike. Because of the excellent performance of UAVs in all aspects, the ability of UAVs to perform tasks is particularly important to the development and progress of the world.

Compared with manned aircraft, UAVs have the advantages of fearless of death, strong survivability, good maneuverability, low development and use cost, and good economy. UAVs have become an important air platform for war and homeland security. If someone piloted a plane to raid the enemy's tight air defense system composed of anti-aircraft missiles, the pilot in the plane would be tantamount to suicide. The biggest advantage of UAVs is that there is no pilot injury or death during the mission, which is also the reason why countries all over the world pay special attention to UAVs. UAVs can perform reconnaissance, surveillance, target positioning and tracking tasks under nuclear, biological, chemical or other life-threatening special conditions. UAVs can act as electronic decoys and pioneers in penetration. Anti-radiation UAVs can do suicide attacks. And UAVs can destroy radars and intercept tactical missiles and cruise missiles. In recent years, thanks to the development of various emerging technologies and micro electronic technology, UAVs have become simple in structure, light in weight, small in size and low in cost, and have become indispensable military equipment and civilian auxiliary equipment for social development.

The execution of tasks by UAVs is called task planning, which is to complete pre-set tasks. With the increase of the depth of research, the risk of UAVs completing the task is also increasing, and the requirements for UAVs are also increasing. From the perspective of UAV task planning, the emergence of a large number of UAVs has led to more and more serious airspace conflicts between UAVs and manned aircrafts. The airspace requirements for UAVs to plan and fly are becoming more and more strict. The development of UAV sensing and evasion technology has become the key to solve this problem. Although the traditional particle swarm optimization (PSO) algorithm is a global optimization algorithm based on swarm intelligence, which has the characteristics of easy implementation and modulation, high precision and good stability, so far, the basic PSO algorithm is prone to premature convergence (especially in dealing with complex multimodal search problems), poor local optimization ability and other problems. PSO algorithm falls into local minimum, which is mainly attributed to the loss of diversity in the search space. The existing task planning methods are inefficient and have poor adaptability. The ability to perform tasks autonomously is insufficient, which mainly requires a lot of human participation. The universality and reliability of the planning are poor, and the planned track is not optimal.

Therefore, how to provide a three-dimensional track planning method based on improved particle swarm optimization algorithm with excellent track planning effect and high efficiency is an urgent problem for those skilled in the art.

### SUMMARY

In view of the above, the present disclosure is to provide a three-dimensional track planning method based on improved particle swarm optimization algorithm. Starting from the motion mechanism of PSO particles, the method adaptively adjusts the inertia weight according to the evolution of the swarm, adds the disturbance mutation operation in the movement process of the particles, makes full use of all particles by virtue of the relationship between the particles and the feasible region, so that the infeasible solutions can also provide help for the overall optimization of the swarm, and ensures the reliability and efficiency of track planning

In order to achieve the above objects, the present disclosure adopts the following technical solutions.

A three-dimensional track planning method based on improved particle swarm optimization algorithm is provided. During the process of searching an optimal three-dimensional track in a track space, the following steps are performed.

Different inertia weights are set in different iterative evolution stages of the particle swarm. A maximum inertia weight is used to make global convergence in a set early stage of evolution, and a minimum inertia weight is used to make local convergence in a set late stage of evolution.

Disturbance mutation operation in a motion process of particles is added based on swarm diversity. The disturbance mutation operation includes position disturbance of particles, mutation update of global extremum and individual extremum, and setting of number of divergence generations of particles.

Infeasible particles are selected based on constraints. Constraint violation functions of infeasible particles are compared, infeasible particles with small constraint violation functions are kept to continue to participate in the iterative evolution of the particle swarm.

Preferably, the track space is set with multiple optimization parameters, that is, for the multi-dimensional track space, different inertia weights are used for different dimensions:

the inertia weights are set to change according to the following rules:

$${w}_{j} ( ℓ ) = \{ \begin{matrix}{w}_{1} , & 0 \leq ℓ < \frac{{ℓ}_{max}}{3} \\ {w}_{0} + ( {w}_{1} - {w}_{0} ) {e}^{- 3 {K}_{w , j}} , & \frac{{ℓ}_{max}}{3} < ℓ < \frac{2 {ℓ}_{max}}{3} \\ {w}_{0} , & \frac{2 {ℓ}_{max}}{3} < ℓ \leq {ℓ}_{max}\end{matrix}$$

wherein, w₀ is a minimum value of the inertia weights, w₁ is a maximum value of the inertia weights, 0≤K_{w,j}≤1, K_{wj} is closeness of particle i to an optimal position of the swarm in the j-th dimensional space, [symbol] is the number of iterations, and [symbol] ₘₐₓ is a maximum number of iterations.

Preferably, when the particle swarm gathers at an optimal track space position in the early set stage of evolution, position disturbance is performed on the set number of particles.

When the global extremum of the particle swarm optimization algorithm has stagnated in a set past stage evolution, a new global extremum is calculated by interpolation algorithm, and it is judged whether the new global extremum is better than the global extremum before calculation, and if so, the global extremum before calculation is replaced by the new global extremum.

When the individual extremum of the particle swarm optimization algorithm has stagnated in a set past evolution stage, reverse mutation is performed on the particle i to calculate a new individual extremum, and it is judged whether the new individual extremum is better than the individual extremum before mutation, and if so, the individual extremum before mutation is replaced by the new individual extremum.

When the swarm diversity of the particle swarm tends to converge in a set early stage of evolution, a set number of particles is selected, and the number of divergence generations of the selected particles is set to make them diverge in a search motion region in the track space.

Preferably, the infeasible particles are particles that do not meet constraints of terminal height, terminal landing, dynamic pressure range and overload range, and a constraint violation function is defined as:

$${f}_{V , i} = \frac{{u}_{V , i}}{{\sum }_{i = 1}^{{M}_{v}} {u}_{V , i}}$$

wherein, Mᵥ is the total number of the infeasible particles in the swarm, and u_{V,i} is the degree evaluation of deviation from a constraint value.

$${u}_{V , i} = \sqrt{{\sum }_{j = 1}^{4} {Ψ}_{j}^{2}}$$

wherein, Ψ₁, Ψ₂, Ψ₃, Ψ₄ are normalized values of the deviation degree of the above four constraints respectively.

Multiple infeasible particles are compared and the infeasible particles with small f_{V,i} are kept.

According to the above technical scheme, compared with the prior art, the disclosure has the following beneficial effects.

The disclosure starts from the motion mechanism of PSO particles, adaptively adjusts the inertia weight according to the evolution of the swarm, adds the disturbance mutation operation in the movement process of the particles, and makes full use of all particles by virtue of the relationship between the particles and the feasible region, so that the infeasible solutions can also provide help for the overall optimization of the swarm, and the reliability and efficiency of track planning are ensured. Compared with the traditional PSO algorithm, the three-dimensional track planned by the method of the disclosure is smoother, the running time is shorter, and the track planning of the improved PSO algorithm has better effect on UAV planning.

### BRIEF DESCRIPTION OF THE DRAWINGS

In order to explain the embodiments of the present disclosure or the technical solutions in the prior art more clearly, the following drawings that need to be used in the description of the embodiments or the prior art will be briefly introduced. Obviously, the drawings in the following description are only embodiments of the present disclosure. For those of ordinary skill in the art, other drawings can be obtained based on the drawings disclosed without creative work.

FIG. 1 is a schematic diagram of the motion mechanism of a single particle in the three-dimensional track planning method based on improved particle swarm optimization algorithm provided by the embodiments of the disclosure.

FIG. 2 is a schematic diagram of disturbance operation to the swarm in the three-dimensional track planning method based on the improved particle swarm optimization algorithm provided by the embodiments of the disclosure.

FIG. 3 is a schematic diagram of the constraint processing mechanism in the three-dimensional track planning method based on the improved particle swarm optimization algorithm provided by the embodiments of the disclosure.

FIG. 4 is a schematic diagram of a three-dimensional simulation scene provided by the embodiments of the present disclosure.

FIG. 5 is a two-dimensional display diagram of the optimal track of the unmanned aerial vehicle based on the improved PSO algorithm provided by the embodiments of the disclosure.

FIG. 6 is a three-dimensional display diagram of the optimal track of the unmanned aerial vehicle based on the improved PSO algorithm provided by the embodiments of the disclosure.

FIG. 7 is a schematic diagram of the relationship between the convergence time and the inertia weights of the basic PSO algorithm provided by the embodiments of the disclosure.

### DETAILED DESCRIPTION OF THE EMBODIMENTS

Technical solutions of the present disclosure will be clearly and completely described below with reference to the embodiments. Obviously, the described embodiments are only part of the embodiments of the present disclosure, not all of them. Based on the embodiments of the disclosure, all other embodiments obtained by those skilled in the art without making creative work belong to the protection scope of the disclosure.

This embodiment designs a highly autonomous and versatile flight track planning method based on the improved PSO algorithm. First, the basic PSO algorithm flow is introduced as follows.

The PSO algorithm uses particles to search for the optimal solution in the search space, each particle represents a potential solution to the optimization problem, and its corresponding performance index is called “fitness”. Assuming that there are Mₚₛₒ particles searching for Dₚₛₒ optimization parameters in the space, the position vector and velocity vector of the i-th (i=1, 2, . . . , M,) particle in the Dₚₛₒ-dimensional search space are:

$$\{ \begin{matrix}{X}_{i} = ( {x}_{i , 1} , {x}_{i , 2} , … , {x}_{i , {D}_{pso}} ) \\ {V}_{i} = ( {v}_{i , 1} , {v}_{i , 2} , … , {v}_{i , {D}_{pso}} )\end{matrix} \qquad ( 1 )$$

At the same time, the best position searched by the i-th particle from the beginning of the algorithm is recorded as Pᵢ, and the fitness corresponding to Pᵢ is p_{best}. Correspondingly, the best position searched by all particles is record as P_{g}, and the fitness corresponding to P_{g} is g_{best}.

$$\{ \begin{matrix}{P}_{i} = ( {p}_{i , 1} , {p}_{i , 2} , … , {p}_{i , {D}_{pso}} ) \\ {P}_{g} = ( {p}_{g , 1} , {p}_{g , 2} , … , {p}_{g , {D}_{pso}} )\end{matrix} \qquad ( 2 )$$

In the basic PSO algorithm, the entire swarm evolves as follows:

[symbol]

= [symbol] +c₁r₁(p_{i,j}− [symbol] )+c₂r₂(p_{g,j}− [symbol] ) (3)

[symbol]

= [symbol] +v_{i,j} [symbol] ⁺¹ (4)

wherein, superscript “ [symbol] ” indicates the current number of iterations, 0<w<1 is inertia weight, c₁ and c₂ are learning factors, which generally take values between 0 and 4, and r₁ and r₂ are random numbers between 0 and 1.

The meanings of each variable are as follows:

1. w indicates that the particle position is affected by the velocity, which makes the particle maintain different motion characteristics (swarm diversity) from other companions.

2. c, determines the degree to which particles are affected by individual experience, which guides the particles to approach Pᵢ.

3. c₂ determines the degree to which particles are affected by swarm experience, which guides the particles to approach P_{g}.

In practical problems, each optimization parameter has its own value range. Therefore, when applying PSO algorithm, the position of each particle in the search space should be limited to a certain range, that is:

x_{Lj}≤x_{i,j}≤x_{Uj} (5)

wherein, x_{Uj} and x_{Lj} are the upper/lower bounds of the j-th dimensional space respectively.

Accordingly, the velocity of particles in the j-th dimension space is also limited within a certain range to prevent particles from jumping out of the space boundary in the next iteration:

x_{Lj}−x_{Ui}≤v_{i,j}≤x_{Uj}−x_{Lj} (6)

In this paper, the swarm diversity at the [symbol] -th generation is defined as:

$${δ}_{swarm}^{ℓ} = \frac{1}{{M}_{pso}} {\sum }_{i = 1}^{{M}_{pso}} \sqrt{{\sum }_{j = 1}^{{D}_{pso}} {( \frac{{x}_{i , j}^{ℓ} - {\overline{x}}_{j}^{ℓ}}{{x}_{Uj} - {x}_{Lj}} )}^{2}} \qquad ( 7 )$$

wherein, x̅ⱼ^{t} is the average position of all particles in the j-th dimension. The calculation of [symbol] takes into account the differences in the value range of different optimization parameters, and [symbol] ∈(0,1).

The maximum number of iterations is set as [symbol] ₘₐₓ, then when [symbol] > [symbol] ₘₐₓ, the PSO algorithm terminates.

The convergence of the basic PSO algorithm is as follows:

Defining ϕ₁=c₁r₁+c₂r₂ and ϕ₂=c₁r₁p_{i,j}+c₂r₂p_{g,j}, it can be obtained from the evolution formula of PSO algorithm:

[symbol]

+(ϕ₁−w−1) [symbol] + [symbol] =ϕ₂ (8)

If the movement of particles is regarded as a continuous process, the above formula is a classical non-homogeneous second-order differential equation without velocity term. The above formula shows that PSO algorithm actually does not need the concept of speed, so it can avoid setting the speed boundary and make the swarm evolution process more concise.

It is assumed that p_{i,j} and p_{g,j} are constant values, which are respectively recorded as p and g. The expectation of a variable is expressed by the symbol [symbol] _{E}. If c₁=c₂=\tilde{c}, then

$$\{ \begin{matrix}{E}_{} ( {r}_{1} ) = {E}_{} ( {r}_{2} ) = 0.5 \\ {E}_{} ( {ϕ}_{1} ) = \tilde{c} \\ {E}_{} ( {ϕ}_{2} ) = \frac{\tilde{c}}{2} ( p + g )\end{matrix} \qquad ( 9 )$$

According to equation (8), there is:

[symbol]

_{E}( [symbol] )=[1+w− [symbol] _{E}(ϕ₁)] [symbol] _{E}( [symbol] )−w [symbol] _{E}( [symbol] )+ [symbol] _{E}(ϕ₂) (10)

When PSO algorithm converges, there is [symbol] _{E} ( [symbol] )= [symbol] _{E}( [symbol] )= [symbol] _{E}( [symbol] ), therefore:

[symbol]

_{E}(ϕ₁)· [symbol] _{E}( [symbol] )= [symbol] _{E}(ϕ₂) (11)

Therefore, a particle of PSO algorithm will converge to the following position in a certain dimension:

$${ℏ}_{E}^{*} = {E}_{} ( {x}_{i , j}^{ℓ} ) \to \frac{{ℏ}_{E} ( {ϕ}_{2} )}{{ℏ}_{E} ( {ϕ}_{1} )} = \frac{p + g}{2} \qquad ( 12 )$$

Assuming that the damping of the second-order system represented by equation (8) is ξₙ and the frequency is ωₙ, then there is

$$\{ \begin{matrix}{ω}_{n} = \sqrt{w} \\ {ξ}_{n} = \frac{{ϕ}_{1} - w - 1}{2 \sqrt{w}}\end{matrix} \qquad ( 13 )$$

Therefore, when ϕ₁−w−1>0, the particle converges gradually to [symbol] *_{E} in the j-th dimension space. This conclusion is obtained under the assumption that p_{i,j} and p_{g,j} are constants, but in fact p_{i,j} and p_{g,j} are dynamic, so the actual motion of the particle is described by multiple second-order differential equations. When the inertia weight is 1, the position of the particle will change according to the sine law, and the particle will continue to jump from one sine wave to another in the process of evolution. Under the influence of random numbers, particles actually spiral around in space.

From equation (13), the convergence condition of the algorithm is ϕ₁−w−1>0. It is set that the algorithm converges when the relative error is less than 2%, and the convergence time is set to tₛ, then:

1. When 0ξₙ<1, equation (8) is an underdamped system, and the convergence time is:

$${t}_{s} = \frac{4 - ln ( 1 - {ξ}_{n}^{2} )}{{ω}_{n} {ξ}_{n}} \qquad ( 14 )$$

2. Because the ϕ₁ in ξₙ is random, ξₙ=1 hardly occurs, so it can be considered that there will be no critical damping system.

3. When ξₙ>1, equation (8) is an overdamped system, and the convergence time is:

$${t}_{s} = \frac{1}{{ω}_{n} ( {ξ}_{n} - \sqrt{{ξ}_{n}^{2} - 1} )} ln \frac{25}{\sqrt{{ξ}_{n}^{2} - 1} ( {ξ}_{n} - \sqrt{{ξ}_{n}^{2} - 1} )} \qquad ( 15 )$$

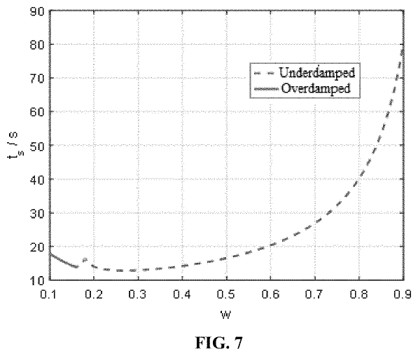

In PSO algorithm, it usually takes c₁=c₂=2.0, so ℏ_{E} (ϕ₁)=2. Taking ϕ₁=2, equation (13) is substituted into equations (14) and (15) respectively, frequency and damping are substituted by inertia weight, and the relationship between the time required for particle convergence and inertia weight is obtained, as shown in FIG. 7.

As can be seen from FIG. 7, in general, the motion of particles around [symbol] *_{E} is basically underdamped, and the convergence time decreases with the decrease of weight. When entering the overdamped state, the convergence time increases with the decrease of the weight. In this paper, it is set that 0.2≤w≤0.9, that is, particles always move in an underdamped state.

It should be noted that in PSO algorithm, the motion of particles is described by the number of iterations, not time. Therefore, the results in FIG. 7 are not the actual convergence time, but only provide a reference for the analysis of particle convergence process.

The derivative of damping to inertia weight is:

$$\frac{d {ξ}_{n}}{d w} = - \frac{( {ϕ}_{1} - 1 ) + w}{4 w \sqrt{w}} \approx - \frac{1 + w}{4 w \sqrt{w}} < 0 \qquad ( 16 )$$

It can be seen that the damping decreases with the increase of inertia weight. Therefore, when the inertia weight is large, the particles converge in the direction of [symbol] *_{E} with a large oscillation amplitude, and the convergence time naturally increase, which is consistent with the conclusion above.

Let the convergence center formed by Pᵢ and P_{g} in the whole search space be:

[symbol]

*_{E}=[ [symbol] *_{E1}, [symbol] _{E2}, . . . , [symbol] *_{ED}_{ₚₛₒ}]^{T} (17)

As the swarm evolves, there will be Pᵢ→P_{g}, [symbol] _{E}→P_{g}.

On the basis of the basic principle of PSO algorithm, the embodiment of the disclosure proposes an improved PSO algorithm based on convergence analysis. The performance of the PSO algorithm is mainly reflected in convergence accuracy and convergence speed. For convergence accuracy, like many intelligent algorithms, the basic PSO algorithm is easy to fall into local optimization, that is, P_{g} only hovers around a non-optimal position, resulting in the final result is not the global optimization. Suppose the theoretical optimal position is [symbol] _{E}^{†}, then the convergence accuracy is ε_{E}=∥ [symbol] _{E}^{†}− [symbol] *_{E}∥₂. Therefore, in order to improve the accuracy, [symbol] *_{E} must be as close to [symbol] _{E}^{†} as possible. In order to improve the convergence speed, the first is to ensure that the particles quickly “fly” to the convergence center [symbol] *_{E} , and the second is to find [symbol] _{E}^{†} as soon as possible.

In the process of particles searching the optimal three-dimensional track in the track space, the following steps are performed.

Different inertia weights are set in different particle swarm iterative evolution stages. A maximum inertia weight is used to make global convergence in a set early stage of evolution, and a minimum inertia weight is used to make local convergence in a set late stage of evolution.

Disturbance mutation operation in a motion process of particles is added based on swarm diversity. The disturbance mutation operation includes position disturbance of particles, mutation update of global extremum and individual extremum, and setting of number of divergence generations of particles.

Infeasible particles are selected based on constraints. Constraint violation functions of infeasible particles are compared, infeasible particles with small constraint violation functions are kept to continue to participate in the iterative evolution of particle swarm.

In one embodiment, the track space is set with multiple optimization parameters, that is, for the multi-dimensional track space, different inertia weights are used for different dimensions:

the inertia weights are set to change according to the following rules:

$${w}_{j} ( ℓ ) = \{ \begin{matrix}{w}_{1} , & 0 \leq ℓ < \frac{{ℓ}_{max}}{3} \\ {w}_{0} + ( {w}_{1} - {w}_{0} ) {e}^{- 3 {K}_{w , j}} , & \frac{{ℓ}_{max}}{3} < ℓ < \frac{2 {ℓ}_{max}}{3} \\ {w}_{0} , & \frac{2 {ℓ}_{max}}{3} < ℓ \leq {ℓ}_{max}\end{matrix} \qquad ( 18 )$$

wherein, w₀ is the minimum value of the inertia weights, w₁ is the maximum value of the inertia weight, 0≤K_{w,j}≤1, K_{wj} is closeness of particle i to an optimal position of the swarm in the j-th dimensional space, [symbol] is the number of iterations, and [symbol] ₘₐₓ is a maximum number of iterations.

In this embodiment, once all particles gather in [symbol] *_{E}, the search of the whole swarm will gradually stop. Therefore, [symbol] *_{E} should be avoided wandering around a non-optimal location, but the space should be constantly searched to increase the chance of finding [symbol] _{E}^{†} and reduce errors. It can be seen from the convergence analysis of PSO algorithm that a larger inertia weight will produce a smaller damping, increase the oscillation amplitude of particles and improve the probability of finding [symbol] _{E}^{†}. At the same time, the earlier [symbol] _{E}^{†} is found, the earlier the algorithm ends. Therefore, large weight is beneficial to reduce the number of generations of swarm evolution and improve the convergence speed. However, from the perspective of individual convergence speed, it is appropriate to use a small inertia weight. Therefore, the effect of inertia weight on convergence accuracy (global convergence) and convergence speed (local convergence) is contradictory.

Compared with the constant inertia weight, the performance of PSO algorithm can be significantly improved by using the inertia weight which changes dynamically with the number of iterations. However, many methods, such as linear weight, exponential weight, random weight, polynomial weight, chaotic weight, can not accurately control the relationship between global convergence and local convergence. At the same time, the inertia weight can not take into account the global convergence and local convergence, so relying solely on the inertia weight can not obtain the best search results.

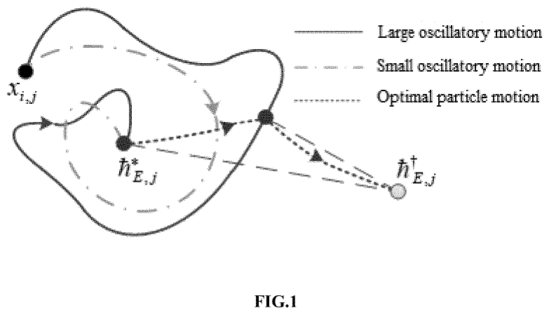

As shown in FIG. 1, the inertia weight is adaptively adjusted according to the swarm evolution. The main principle is: using large inertia weight to promote global convergence in the early stage of evolution, and using small inertia weight to promote local convergence in the late stage of evolution. In addition, since the optimization problem studied in this embodiment involves many optimization parameters, the search space dimension is high, and different inertia weights need to be used for different dimensions.

In the inertia weight law change formula, there is:

$${K}_{w , j} = \frac{\vert {p}_{i , j} - {p}_{g , j} \vert}{{‖ {P}_{i} - {P}_{g} ‖}_{2}} \qquad ( 19 )$$

Obviously, 0≤K_{wj}≤1. K_{wj} represents the closeness of particle i to the optimal position of the swarm in the j-dimensional space. The smaller K_{wj} indicates that the motion range of the particle in this dimension is too small. The weight should be increased to intensify the motion oscillation of the particle, so that it can search in this dimension more comprehensively.

In one embodiment, the disturbance mutation operation based on swarm diversity includes the following specific contents:

Equation (8) is rewritten as follows:

x_{i,j}ⁱ⁺²+[(ϕ₁−1)−(w−r₃)]x_{i,j}ⁱ⁺¹+(w+r₄)x_{i,j}^{t}=ϕ₂ (20)

wherein, r₃ and r₄ are random numbers between 0 and 1.

At this point, the convergence condition of the second-order system becomes ϕ₁≠1−w+r₃>0. Compared with equation (8), equation (20) is equivalent to adding a random number to the frequency and damping of the original second-order system respectively, which makes the motion process of particles subject to random disturbance, so as to search in space more fully. At the same time, it can improve the swarm diversity and help to find better Pᵢ and P_{g}.

In fact, the above method is to make the particles find a better position in the process of motion, but the effect is not obvious in practical application. Since P_{g} is the main direction of motion of particles, particles mainly gather around P_{g}. If [symbol] _{E}^{†} generated by random initialization is far away from P_{g}, the swarm will be difficult to find [symbol] _{E}^{†}. Therefore, in order to make the particles fully search the space, the motion law of the particles must be changed.

When it evolves to the j-th generation, the value of P_{g} is recorded as [symbol] , and the value of Pᵢ is recorded as [symbol] . The follows are calculated separately:

$${Δ}_{g} = \frac{1}{{ℓ}_{g}} {{\sum }_{k = ℓ - {ℓ}_{g}}}^{ℓ} {‖ {P}_{g}^{ℓ} - {P}_{g}^{k} ‖}_{2} \qquad ( 21 )$$

$${Δ}_{i} = \frac{1}{{ℓ}_{i}} {{\sum }_{k = ℓ - {ℓ}_{i}}}^{ℓ} {‖ {P}_{i}^{ℓ} - {P}_{i}^{k} ‖}_{2} \qquad ( 22 )$$

$${Δ}_{δ} = \frac{1}{{ℓ}_{δ}} {{\sum }_{k = ℓ - {ℓ}_{δ}}}^{ℓ} \vert {δ}_{swarm}^{ℓ} - {δ}_{swarm}^{k} \vert \qquad ( 23 )$$

wherein, [symbol] _{g}, [symbol] ᵢ, [symbol] _{δ} are the number of generations considered in calculating Δ_{g} , Δᵢ and Δ_{δ}.

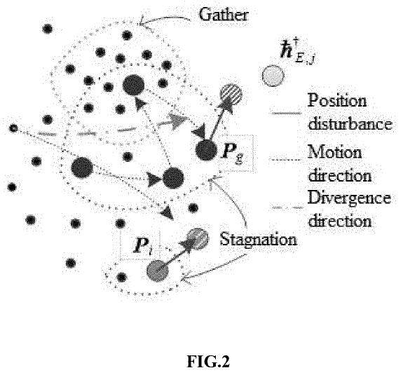

1. As shown in FIG. 2, when the particle swarm gathers at an optimal track space position in the early set stage of evolution, position disturbance is performed on the set number of particles.

The top 20% of particles are selected to subject to the position disturbance:

$${X}_{i} = {X}_{i} ( 1 + {r}_{5} {K}_{wj} \frac{{ℓ}_{max} - ℓ}{{ℓ}_{max}} ) \qquad ( 24 )$$

wherein, r₅ is a random integer equal to 2 or −2. The above formula shows that the mutation range of particles gradually decreases with the increase of number of iterations, which is conducive to promoting convergence to [symbol] *_{E} in the late evolution.

2. When the global extremum of particle swarm optimization algorithm has stagnated in a set past stage evolution, a new global extremum is calculated by interpolation algorithm, and it is judged whether the new global extremum is better than the global extremum before calculation, and if so, the global extremum before calculation is replaced by the new global extremum.

When Δ_{g}<ε_{g} , it indicates that the global extremum has stagnated in the past [symbol] _{g} generation.

At this time, according to the change history of P_{g}, a new global extremum P̅_{g} is obtained by interpolation:

P̅_{g}=f₃( [symbol] , [symbol] , . . . , [symbol] ,) (25)

wherein, f₃ is cubic spline interpolation function. If P̅_{g} is better than P_{g}, let P_{g}=P̅_{g}. Otherwise, P_{g} is kept.

3. When the individual extremum of particle swarm optimization algorithm has stagnated in the set past evolution stage, reverse mutation is performed on the particle i to calculate a new individual extremum, and it is judged whether the new individual extremum is better than the individual extremum before mutation, and if so, the individual extremum before mutation is replaced by the new individual extremum.

When Δᵢ<εᵢ, it indicates that the individual extremum has stagnated in the past [symbol] , generation.

At this point, reverse mutation is performed on the particle:

P̅=−Pᵢ (26)

If P̅ᵢ is better than Pᵢ, Pᵢ is replaced by P̅ᵢ. Otherwise, Pᵢ is kept.

4. When the swarm diversity of the particle swarm tends to converge in the set early stage of evolution, a set number of particles is selected, and the numberof divergence generations of the selected particles is set to make them diverge in a search motion region in the track space.

When Δ_{δ}<ε_{Δ} and [symbol] < [symbol] ₘₐₓ/2, it indicates that the swarm diversity has not been improved.

At this time, the weight modification or position disturbance can no longer effectively improve the search efficiency of the algorithm, and the particle motion state needs to be greatly changed. The top 10% of the particles are selected, and r₁ and r₂ are adjusted to make ϕ₁−w−1<0, that is, to make the motion of some particles tend to diverge. The number of divergence generations is calculated as follows:

$${ℓ}_{D , k} = \frac{{Δ}_{i}}{{{\sum }_{{i}_{D} - 1}}^{{N}_{D}} {Δ}_{{i}_{D}}} {ℓ}_{D} \qquad ( 27 )$$

wherein, N_{D} is the number of selected particles, [symbol] _{D,k} is the number of divergence generations of the k-th particle among the selected particles, and [symbol] _{D} is the maximum number of divergence generations.

In the present embodiment, there are max [symbol] _{g}= [symbol] ₘₐₓ/4, [symbol] ᵢ= [symbol] ₘₐₓ/5, [symbol] _{δ}= [symbol] ₘₐₓ/4, and [symbol] _{D}= [symbol] ₘₐₓ/6.

In one embodiment, it is noted that the particles satisfying all constraints are feasible particles, and vice versa are infeasible particles. Constraints can be processed through simple comparison. When comparing two particles:

1. if both are feasible, the fitness values are compared, and the one with the smaller fitness value wins;

2. if one is feasible and the other is not, the feasible particle wins; and

3. if neither is feasible:

a) the constraint violation function is defined as:

$${f}_{V , i} = \frac{{u}_{V , i}}{{\sum }_{i = 1}^{{M}_{v}} {u}_{V , i}} \qquad ( 28 )$$

wherein, Mᵥ is the total number of infeasible particles in the swarm, u_{V,i} is a degree evaluation of deviation from constraint value.

$${u}_{V , i} = \sqrt{{\sum }_{j = 1}^{4} {Ψ}_{j}^{2}}$$

wherein, Ψ₁, Ψ₂, Ψ₃, Ψ₄ are normalized values of the deviation degree of the above four constraints respectively.

b) the one with small f_{V,i} wins.

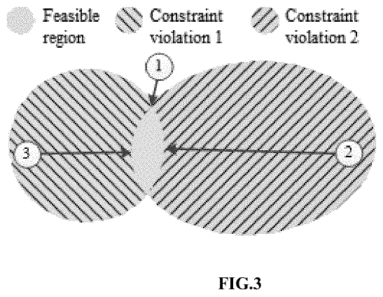

The comparison principles described above are used to select P_{g} in the swarm. As shown in FIG. 3, when comparing three infeasible particles, although particle □ violates more constraints, it is closer to the feasible region and thus is considered to be more optimal. The winning particles continue to participate in the optimization iteration, while the non-winning particles are directly discarded due to violation of constraints.

Different from the commonly used penalty function method, the comparison method proposed in this embodiment makes full use of all particles by virtue of the relationship between particles and feasible region, so that the infeasible solutions can also provide help for the overall optimization of the swarm, and the efficiency of the algorithm is ensured while solving the constraints.

The process and results of the method of the disclosure in UAV aviation track analysis are given below.

Algorithm environment: Windows? 64 bit, Matlab R2017a. Processor: Intel® Core™ i5-5200U. Main frequency: 2.2 GHz. Computer RAM: 8 GB.

In order to verify the effectiveness of the algorithm in three-dimensional space, different from two-dimensional track planning, the environment model was established considering the impact of flight height on the track, and then the simulation was carried out. Two topographic maps were designed for simulation verification.

The initial conditions are as follows.

1. The constraint parameters of UAV flight capability set in this embodiment are as follows.

(1) The maximum air-range was 40 km.

(2) the minimum route segment distance was 0.8 km.

(3) The maximum number of waypoints was 20.

(4) The maximum turning angle was 90 °.

(5) The average flight speed of the UAV was 200 m/s.

(6) The shortest allowable interval between two routes was 0.5 km.

(7) The UAV take-off preparation time was 10 s.

(8) The minimum height of the UAV above the ground was 200 m.

2. Settings of optimization variables

[symbol] ₘₐₓ was taken as [symbol] ₘₐₓ=20, and c₁ and c₂ were taken as c₁=c₂=2.0. In equation (18), w₀ was taken as w₀=0.1, and w₁ was taken as w₁=0.9.

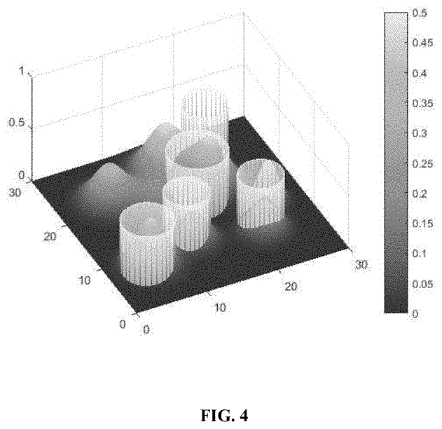

The three-dimensional space of the three-dimensional simulation scene was 30 km long, 30 km wide, and 1 km high. It consisted of six peaks with different heights and five defense circles. The UAV track planning were carried out in this space, as shown in FIG. 4.

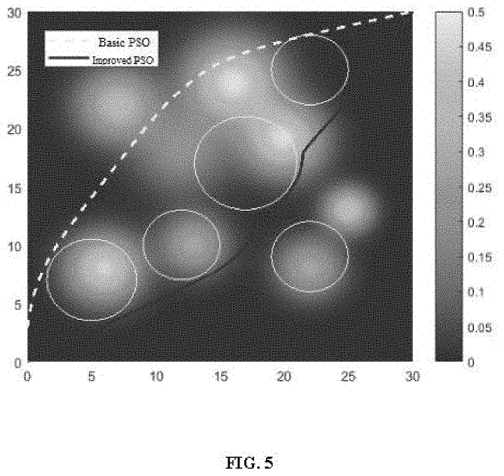

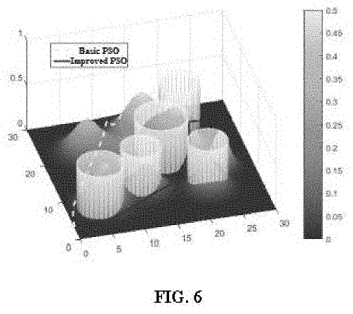

The track of the UAV was optimized based on the improved PSO algorithm, and the results are shown in FIG. 5 and FIG. 6. Table 1 is the simulation data of the evaluation criteria of the basic PSO algorithm and the improved PSO algorithm of the present disclosure to optimize the track of the UAV.

TABLE 1
Simulation data of 3D simulation scene

| Track Evaluation Criteria | Basic PSO | Improved PSO |
|---|---|---|
| Track optimum | 45.13 | 43.94 |
| Track average | 46.58 | 44.10 |
| Average running time | 18.629 | 12.925 |
| Standard deviation | 0.5964 | 0.2616 |
| Track maximum | 46.69 | 44.19 |

The simulation results are analyzed as follows.

FIG. 5 and FIG. 6 respectively show the effect of track planning from the starting point 0 to the target point 30 km. In this embodiment, two algorithms are selected for comparative analysis, namely, the basic PSO algorithm and the improved PSO algorithm. From the effects comparison of track planning from FIG. 5 and FIG. 6, it is obvious that the planned track is relatively smooth, and from Table 1, it can be seen that the shortest track of the improved PSO algorithm in this embodiment was 43.94 km, and the average track value was 44.10 km. Therefore, based on the comparison of the two algorithms, the track planning of the improved PSO algorithm of the disclosure has better effect on UAV planning

The above describes in detail the three-dimensional track planning method based on the improved particle swarm optimization algorithm provided by the disclosure. In the specification, specific embodiments are used to explain the principle and implementation mode of the disclosure. The description of the above embodiments is only used to help understand the method and core idea of the disclosure. Meanwhile, for those skilled in the art, there will be changes in the specific implementation mode and application scope according to the idea of the disclosure. In conclusion, the contents of this specification shall not be construed as limiting the disclosure.

The above description of the disclosed embodiments enables the skilled in the art to achieve or use the disclosure. Multiple modifications to these embodiments will be apparent to those skilled in the art, and the general principles defined herein may be achieved in other embodiments without departing from the spirit or scope of the disclosure. The present disclosure will therefore not be restricted to these embodiments shown herein, but rather to comply with the broadest scope consistent with the principles and novel features disclosed herein.

What is claimed is:

1. A three-dimensional track planning method based on improved particle swarm optimization algorithm, wherein during the process of particles searching an optimal three-dimensional track in a track space, the method comprises following steps:
different inertia weight settings in different iterative evolution stages of the particle swarm: using a maximum inertia weight to make global convergence in a set early stage of evolution, and using a minimum inertia weight to make local convergence in a set late stage of evolution;
adding disturbance mutation operation in a motion process of particles based on swarm diversity, wherein the disturbance mutation operation comprises position disturbance of particles, mutation update of global extremum and individual extremum, and setting of number of divergence generations of particles; and
selection of infeasible particles based on constraints: comparing constraint violation functions of infeasible particles, keeping infeasible particles with small constraint violation functions to continue to participate in the iterative evolution of the particle swarm, and discarding non-winning particles directly due to violating constraints.

2. The three-dimensional track planning method based on improved particle swarm optimization algorithm of claim 1, wherein the track space is set with multiple optimization parameters, that is, for the multi-dimensional track space, different inertia weights are used for different dimensions:
the inertia weights are set to change according to the following rules:
$${w}_{j} ( ℓ ) = \{ \begin{matrix}{w}_{1} , & 0 \leq ℓ < \frac{{ℓ}_{max}}{3} \\ {w}_{0} + ( {w}_{1} - {w}_{0} ) {e}^{- 3 {K}_{w , j}} , & \frac{{ℓ}_{max}}{3} < ℓ < \frac{2 {ℓ}_{max}}{3} \\ {w}_{0} , & \frac{2 {ℓ}_{max}}{3} < ℓ \leq {ℓ}_{max}\end{matrix}$$
wherein, w₀ is the minimum value of the inertia weights, w₁ is the maximum value of the inertia weights, 0≤K_{w,j}≤1, K_{wj} is a closeness of particle i to an optimal position of the swarm in the j-th dimensional space, [symbol] is the number of iterations, and [symbol] ₘₐₓ is the maximum number of iterations.

3. The three-dimensional track planning method based on improved particle swarm optimization algorithm of claim 1, wherein
when the particle swarm gathers at an optimal track space position in the early set stage of evolution, position disturbance is performed on a set number of particles;
when the global extremum of the particle swarm optimization algorithm has stagnated in a set past stage evolution, a new global extremum is calculated by interpolation algorithm, and it is judged whether the new global extremum is better than the global extremum before calculation, and if so, the global extremum before calculation is replaced by the new global extremum;
when the individual extremum of the particle swarm optimization algorithm has stagnated in a set past evolution stage, reverse mutation is performed on the particle i to calculate a new individual extremum, and it is judged whether the new individual extremum is better than the individual extremum before mutation, and if so, the individual extremum before mutation is replaced by the new individual extremum; and
when the swarm diversity of the particle swarm tends to converge in the set early stage of evolution, a set number of particles is selected, and the number of divergence generations of the selected particles is set to make them diverge in a search motion region in the track space.

4. The three-dimensional track planning method based on improved particle swarm optimization algorithm of claim 1, wherein the infeasible particles are particles that do not meet constraints of terminal height, terminal landing, dynamic pressure range and overload range, and a constraint violation function is defined as:
$${f}_{V , i} = \frac{{u}_{V , i}}{{\sum }_{i = 1}^{{M}_{v}} {u}_{V , i}}$$
wherein, Mᵥ is a total number of the infeasible particles in the swarm; u_{V,i} is a degree evaluation of deviation from a constraint value;
$${u}_{V , i} = \sqrt{{\sum }_{j = 1}^{4} {Ψ}_{j}^{2}}$$
wherein, Ψ₁, Ψ₂, Ψ₃, Ψ₄are normalized values of the deviation degree of the above four constraints respectively; and
a plurality of infeasible particles are compared and the infeasible particles with small f_{V,i} are kept.
